(19) United States
(12) Patent Application Publication
(10) Pub. No.: US 2025/0033330 A1
(43) Pub. Date: Jan. 30, 2025

(54) COMPOSITE TRANSPARENT BOARD AND METHOD FOR PRODUCING THE SAME

(71) Applicant: NAN YA PLASTICS CORPORATION, TAIPEI (TW)

(72) Inventors: TE-CHAO LIAO, TAIPEI (TW); CHUN-CHE TSAO, TAIPEI (TW); WEN-JUI CHENG, TAIPEI (TW); Yueh-Shin Liu, Taipei City (TW)

(21) Appl. No.: 18/371,520

(22) Filed: Sep. 22, 2023

(30) Foreign Application Priority Data
Jul. 28, 2023 (TW) 112128297

(51) Int. Cl. B32B 27/08; B32B 7/02; B32B 27/36

(52) U.S. Cl. CPC B32B 27/08; B32B 7/02; B32B 27/36; B29C 48/08; B29C 48/21; B29K 2067/003; B29K 2995/0026; B29K 2995/0097; B32B 2250/244; B32B 2250/40; B32B 2307/412; B32B 2307/414; B32B 2307/7376

(57) ABSTRACT

A composite transparent board and method for producing the same are provided. The method includes a feeding step and a forming step. In the feeding step, a first resin, a second resin, and a third resin are respectively fed into a first extruder, a second extruder, and a third extruder to correspondingly form a composite transparent film having a first layer, a second layer, and a third layer. The first resin is selected from the group consisting of Tairilin 3824, Tairilin 3842, Tairilin 390A, Tairilin P115, Tairilin 663G, and SKYGREEN® S2008. In the forming step, the composite transparent film sequentially passes through a first forming wheel, a second forming wheel, and a third forming wheel to form a composite transparent board. The composite transparent board has a haze within a range from 0.75% to 4% and a total light transmittance within a range from 86% to 91.5%.

### CROSS-REFERENCE TO RELATED PATENT APPLICATION

This application claims the benefit of priority to Taiwan Patent Application No. 112128297, filed on Jul. 28, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a composite transparent board and method for producing the same, and more particularly to a PET composite transparent board and method for producing the same.

### BACKGROUND OF THE DISCLOSURE

Since a conventional PET transparent board is generally made of a single material, optimization cannot be performed for different layers of the conventional PET transparent board. In addition, the conventional PET transparent board has a crystallizing and whitening phenomenon during a forming process thereof.

### SUMMARY OF THE DISCLOSURE

In response to the above-referenced technical inadequacies, the present disclosure provides a composite transparent board and method for producing the same to improve on a conventional transparent board that may have a crystallizing and whitening phenomenon during a forming process thereof.

In order to solve the above-mentioned problems, one of the technical aspects adopted by the present disclosure is to provide a method for producing a composite transparent board. The method includes a feeding step and a forming step. The feeding step is implemented by respectively feeding a first resin, a second resin, and a third resin into a first extruder, a second extruder, and a third extruder to correspondingly form a composite transparent film including a first layer, a second layer, and a third layer. The first resin is selected from the group consisting of Tairilin 3824, Tairilin 3842, Tairilin 390A, Tairilin P115, Tairilin 663G, and SKYGREEN® S2008, the second resin is selected from the group consisting of Tairilin 3760 and Tairilin 3842, and the third resin is selected from the group consisting of Tairilin 3760, Tairilin 3842, Tairilin 380R, and Tairilin 384R. The forming step is implemented by sequentially passing the composite transparent film through a first forming wheel, a second forming wheel, and a third forming wheel to form a composite transparent board. An absolute value of a difference between a temperature of the first forming wheel and a temperature of the second forming wheel is less than or equal to 5° C., and a ratio between a temperature of the third forming wheel and the temperature of the first forming wheel or the temperature of the second forming wheel is within a range from 1.8 to 3.5. The composite transparent board has a haze within a range from 0.75% to 4% and a total light transmittance within a range from 86% to 91.5%.

In one of the possible or preferred embodiments, the first resin has an intrinsic viscosity within a range from 0.63 dl/g to 1.1 dl/g, the second resin has an intrinsic viscosity within a range from 0.76 dl/g to 1.1 dl/g, and the third resin has an intrinsic viscosity within a range from 0.76 dl/g to 1.1 dl/g.

In certain embodiments, the temperature of the first forming wheel is within a range from 18° C. to 25° C., the temperature of the second forming wheel is within a range from 18° C. to 25° C., and the temperature of the third forming wheel is within a range from 35° C. to 58° C.

In one of the possible or preferred embodiments, the second layer, and the third layer of the composite transparent board are arranged, from top to bottom, in one of following sequences: the third layer, the second layer, the first layer, the second layer, and the third layer; the third layer, the second layer, the first layer, and the second layer; the third layer, the second layer, the first layer, and the third layer; and the third layer, the second layer, and the first layer.

In one of the possible or preferred embodiments, based on a thickness of the composite transparent board being 100%, a thickness of the first layer accounts for 40% to 70%, a thickness of the second layer accounts for 15% to 40%, and a thickness of the third layer accounts for 10% to 20%.

In certain embodiments, a thickness of the composite transparent board is within a range from 0.5 mm to 8 mm.

In order to solve the above-mentioned problems, another one of the technical aspects adopted by the present disclosure is to provide a composite transparent board that includes a first layer, a second layer, and a third layer. The first layer is made of a first resin, and the first resin is selected from the group consisting of Tairilin 3824, Tairilin 3842, Tairilin 390A, Tairilin P115, Tairilin 663G, and SKYGREEN® S2008. The second layer is made of a second resin, and the second resin is selected from the group consisting of Tairilin 3760 and Tairilin 3842. The third layer is made of a third resin, and the third resin is selected from the group consisting of Tairilin 3760, Tairilin 3842, Tairilin 380R, and Tairilin 384R. The composite transparent board has a haze within a range from 0.75% to 4% and a total light transmittance within a range from 86% to 91.5%.

In one of the possible or preferred embodiments, the first resin has an intrinsic viscosity within a range from 0.63 dl/g to 1.1 dl/g, the second resin has an intrinsic viscosity within a range from 0.76 dl/g to 1.1 dl/g, and the third resin has an intrinsic viscosity within a range from 0.76 dl/g to 1.1 dl/g.

In one of the possible or preferred embodiments, the first layer, the second layer, and the third layer of the composite transparent board are arranged, from top to bottom, in one of following sequences: the third layer, the second layer, the first layer, the second layer, and the third layer; the third layer, the second layer, the first layer, and second layer; the third layer, the second layer, the first layer, and the third layer; and the third layer, the second layer, and first layer.

In one of the possible or preferred embodiments, based on a thickness of the composite transparent board being 100%, a thickness of the first layer accounts for 40% to 70%, a thickness of the second layer accounts for 15% to 40%, and a thickness of the third layer accounts for 10% to 20%.

Therefore, in the composite transparent board and method for producing the same provided by the present disclosure, by virtue of the first resin being selected from the group consisting of Tairilin 3824, Tairilin 3842, Tairilin 390A, Tairilin P115, Tairilin 663G, and SKYGREEN® S2008, the second resin being selected from the group consisting of Tairilin 3760 and Tairilin 3842, and the third resin being selected from the group consisting of Tairilin 3760, Tairilin 3842, Tairilin 380R, and Tairilin 384R, the crystallizing and whitening phenomenon of the conventional transparent board during a forming process thereof can be prevented.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method for producing a composite transparent board according to an embodiment of the present disclosure; and

FIG. 2 to FIG. 6 are schematic views of composite transparent boards of different embodiments of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### [Method for Producing a Composite Transparent Board]

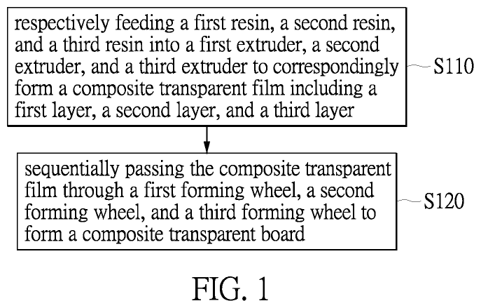

Referring to FIG. 1, FIG. 1 is a flowchart of a method for producing a composite transparent board according to an embodiment of the present disclosure. A method for producing a composite transparent board includes a feeding step S110 and a forming step S120, and the method for producing the composite transparent board can include other steps according to practical requirements, but the present disclosure is not limited thereto.

The feeding step S110 is implemented by respectively feeding a first resin, a second resin, and a third resin into a first extruder, a second extruder, and a third extruder to correspondingly form a composite transparent film including a first layer A, a second layer B, and a third layer C. Specifically, the first resin, the second resin, and the third resin can be fed into the first extruder, the second extruder, and the third extruder in form of particles.

The first resin is selected from the group consisting of Tairilin 3824, Tairilin 3842, Tairilin 390A, Tairilin P115, Tairilin 663G, and SKYGREEN® S2008, the second resin is selected from the group consisting of Tairilin 3760 and Tairilin 3842, and the third resin is selected from the group consisting of Tairilin 3760, Tairilin 3842, Tairilin 380R, and Tairilin 384R.

A melting temperature of Tairilin 3824 is 238° C., a melting temperature of Tairilin 3842 is 246° C., a melting temperature of Tairilin 390A is 228° C., a melting temperature of Tairilin P115 is 228° C., Tairilin 663G does not have a melting temperature, SKYGREEN® S2008 does not have a melting temperature, a melting temperature of Tairilin 380R is 248° C., and a melting temperature of Tairilin 384R is 248° C.

A melting temperature of the first resin can be within a range from 228° C. to 246° C., or the first resin can have no melting temperature, a melting temperature of the second resin can be within a range from 246° C. to 255° C., and a melting temperature of the third resin can be within a range from 246° C. to 255° C.

The first resin has an intrinsic viscosity within a range from 0.63 dl/g to 1.1 dl/g, the second resin has an intrinsic viscosity within a range from 0.76 dl/g to 1.1 dl/g, and the third resin has an intrinsic viscosity within a range from 0.76 dl/g to 1.1 dl/g. Preferably, the second resin has the intrinsic viscosity within a range from 0.76 dl/g to 0.84 dl/g, and the third resin has the intrinsic viscosity within a range from 0.76 dl/g to 0.84 dl/g.

In one embodiment, the first resin can be copolyester formed by copolymerizing an alcohol being at least one of ethylene glycol, propylene glycol, and 1,4-cyclohexanedimethanol and an acid being at least one of isophthalic acid, terephthalic acid, and 2,6-naphthalene dicarboxylic acid. In one embodiment, the second resin and the third resin are polyethylene terephthalate or a modified polyester composition, but the present disclosure is not limited thereto.

The first resin includes diol residue and dicarboxylic acid residue, based on the dicarboxylic acid residue being 100 mole %, a content of terephthalic acid residue is within a range from 70 mole % to 99 mole %, a content of isophthalic acid residue is within a range from 1 mole % to 30 mole %, and a content of 2,6-naphthalene dicarboxylic acid residue is within a range from 0 mole % to 30 mole %. Based on the diol residue being 100 mole %, a content of ethylene glycol residue is within a range from 50 mole % to 100 mole %, a content of propylene glycol residue is within a range from 0 mole % to 50 mole %, and a content of cyclohexanedimethanol residue is within a range from 0 mole % to 50 mole %. The isophthalic acid residue has an effect of inhibiting crystallinity, such that the first resin can have the specific melting temperature.

The forming step S120 is implemented by moving the composite transparent film to sequentially pass through a first forming wheel, a second forming wheel, and a third forming wheel to form a composite transparent board 100.

An absolute value of a difference between a temperature of the first forming wheel and a temperature of the second forming wheel is less than or equal to 5° C., and a ratio between a temperature of the third forming wheel and the temperature of the first forming wheel or the temperature of the second forming wheel is within a range from 1.8 to 3.5. In other words, the temperature of the first forming wheel and the temperature of the second forming wheel are close to each other, and the temperature of the first forming wheel can be greater than, equal to, or less than the temperature of the second forming wheel. Preferably, the ratio between the temperature of the third forming wheel and the temperature of the first forming wheel or the temperature of the second forming wheel is within the range from 1.8 to 3.5.

In the present embodiment, the temperature of the first forming wheel is within a range from 18° C. to 25° C., the temperature of the second forming wheel is within a range from 18° C. to 25° C., and the temperature of the third forming wheel is within a range from 35° C. to 58° C. Preferably, the temperature of the first forming wheel is within a range from 18° C. to 20° C., the temperature of the second forming wheel is within a range from 18° C. to 22° C., and the temperature of the third forming wheel is within a range from 51° C. to 58° C. It is worth mentioning that, in the forming step S120 of the present embodiment, the first forming wheel and the second forming wheel are used to cool down the composite transparent film, and the third forming wheel is used to eliminate a stress of the composite transparent board 100.

It is worth mentioning that, the first extruder, the second extruder, the third extruder, the first forming wheel, the second forming wheel, and the third forming wheel of the present disclosure can be changed according to practical requirements or can be conventional structures, and as long as the first extruder, the second extruder, the third extruder, the first forming wheel, the second forming wheel, and the third forming wheel can be used to implement the method for producing the composite transparent board, the present disclosure does not limit the specific structures of the above-mentioned devices.

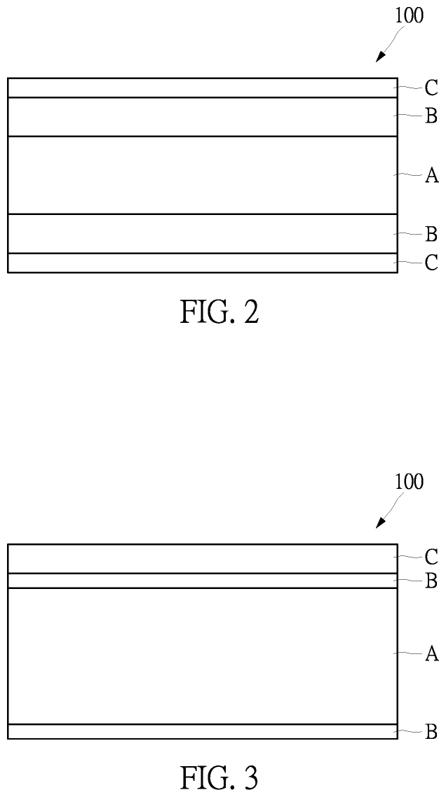

Referring to FIG. 2 to FIG. 6, FIG. 2 to FIG. 6 are schematic views of composite transparent boards of different embodiments of the present disclosure. The composite transparent board 100 can be a three-layered structure, a four-layered structure, or a five-layered structure. Specifically, the first layer, the second layer, and the third layer of the composite transparent board are arranged, from top to bottom, in one of following sequences: the third layer, the second layer, the first layer, the second layer, and the third layer; the third layer, the second layer, the first layer, and the second layer; the third layer, the second layer, the first layer, and the third layer; and the third layer, the second layer, and the first layer. However, in other embodiments, the specific stacking sequence of the first layer, the second layer, and the third layer of the composite transparent board 100 can be changed according to practical requirements, and the present disclosure is not limited thereto.

In terms of thickness, based on 100% of a thickness of the composite transparent board 100, a thickness of the first layer A accounts for 40% to 70%, a thickness of the second layer B accounts for 15% to 40%, and a thickness of the third layer C accounts for 10% to 20%. The thickness of the composite transparent board 100 can be within a range from 0.5 mm to 8 mm. Preferably, the thickness of the composite transparent board 100 can be within a range from 2 mm to 8 mm.

It is worth mentioning that, the quantity of the second layer B and the quantity of the third layer C can be one or two, and when the quantity of the second layer B or the quantity of the third layer C is two, the above-mentioned thickness of the second layer B refers to a total thickness of the two second layers B, and the above-mentioned thickness of the third layer C refers to a total thickness of the two third layers C.

The composite transparent board 100 has a haze within a range from 0.75% to 4% and a total light transmittance within a range from 86% to 91.5%. It is worth mentioning that, the total light transmittance is measured with light having a wavelength within a range from 400 nm to 800 nm according to ISO 14782.

### [Composite Transparent Board]

The embodiment of the present disclosure also provides a composite transparent board 100, and the composite transparent board 100 can be obtained by implementing the above-mentioned method for producing the composite transparent board, but the present disclosure is not limited thereto.

The composite transparent board 100 includes a first layer A, a second layer B, and a third layer C. The first layer A is made of a first resin, and the first resin is selected from the group consisting of Tairilin 3824, Tairilin 3842, Tairilin 390A, Tairilin P115, Tairilin 663G, and SKYGREEN® S2008. The second layer B is made of a second resin, and the second resin is selected from the group consisting of Tairilin 3760 and Tairilin 3842. The third layer is made of a third resin, and the third resin is selected from the group consisting of Tairilin 3760, Tairilin 3842, Tairilin 380R, and Tairilin 384R. Preferably, a material of the first resin is not the same as a material of the second resin and a material of the third resin at the same time.

The first resin has an intrinsic viscosity within a range from 0.63 dl/g to 1.1 dl/g, the second resin has an intrinsic viscosity within a range from 0.76 dl/g to 1.1 dl/g, and the third resin has an intrinsic viscosity within a range from 0.76 dl/g to 1.1 dl/g. Preferably, the second resin has the intrinsic viscosity within a range from 0.76 dl/g to 0.84 dl/g, and the third resin has the intrinsic viscosity within a range from 0.76 dl/g to 0.84 dl/g.

The composite transparent board 100 can be a three-layered structure, a four-layered structure, or a five-layered structure. Specifically, the first layer, the second layer, and the third layer of the composite transparent board are arranged, from top to bottom, in one of following sequences: the third layer, the second layer, the first layer, the second layer, and the third layer; the third layer, the second layer, the first layer, and the second layer; the third layer, the second layer, the first layer, and the third layer; and the third layer, the second layer, and the first layer.

Based on 100% of a thickness of the composite transparent board 100, a thickness of the first layer A accounts for 40% to 70%, a thickness of the second layer B accounts for 15% to 40%, and a thickness of the third layer C accounts for 10% to 20%.

The composite transparent board 100 has a haze within a range from 0.75% to 4% and a total light transmittance within a range from 86% to 91.5%.

### [Experimental Results]

Hereinafter, a more detailed description will be provided with reference to Exemplary Examples 1 to 6 and Comparative Examples 1 and 2. However, the Exemplary Examples below are only used to aid in understanding of the present disclosure, and are not to be construed as limiting the scope of the present disclosure.

In Exemplary Example 1, the first resin is Tairilin 3824, the second resin is Tairilin 3760, the third resin is Tairilin 3760, the intrinsic viscosity of the first resin is 0.82 dl/g, the intrinsic viscosity of the second resin is 0.76 dl/g, the intrinsic viscosity of the third resin is 0.76 dl/g, the thickness of the first layer accounts for 40%, the thickness of the second layer accounts for 40%, the thickness of the third layer accounts for 20%, the temperature of the first forming wheel is 18° C., the temperature of the second forming wheel is 18° C., the temperature of the third forming wheel is 51° C., the composite transparent board includes five layers in total (as shown in FIG. 2), and the stacking sequence is C/B/A/B/C with “A” representing the first layer, “B” representing the second layer, and “C” representing the third layer.

In Exemplary Example 2, the first resin is Tairilin 3842, the second resin is Tairilin 3842, the third resin is Tairilin 3760, the intrinsic viscosity of the first resin is 0.84 dl/g, the intrinsic viscosity of the second resin is 0.84 dl/g, the intrinsic viscosity of the third resin is 0.76 dl/g, the thickness of the first layer accounts for 70%, the thickness of the second layer accounts for 15%, the thickness of the third layer accounts for 15%, the temperature of the first forming wheel is 20° C., the temperature of the second forming wheel is 20° C., the temperature of the third forming wheel is 58° C., the composite transparent board includes four layers in total (as shown in FIG. 3), and the stacking sequence is C/B/A/B.

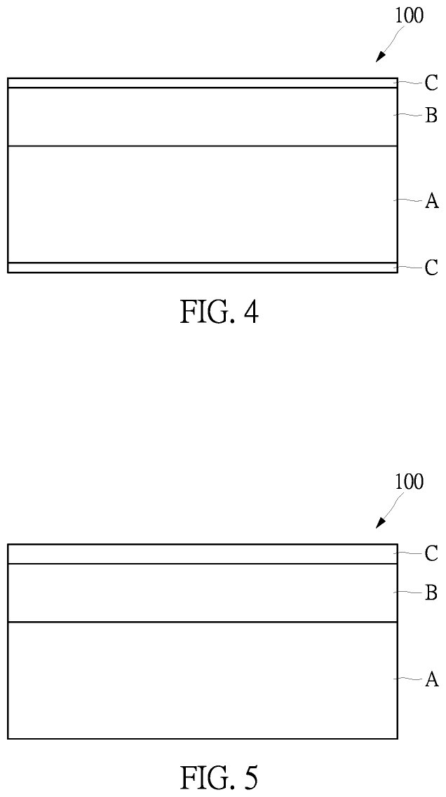

In Exemplary Example 3, the first resin is Tairilin 390A, the second resin is Tairilin 3842, the third resin is Tairilin 3842, the intrinsic viscosity of the first resin is 0.9 dl/g, the intrinsic viscosity of the second resin is 0.84 dl/g, the intrinsic viscosity of the third resin is 0.84 dl/g, the thickness of the first layer accounts for 60%, the thickness of the second layer accounts for 30%, the thickness of the third layer accounts for 10%, the temperature of the first forming wheel is 18° C., the temperature of the second forming wheel is 18° C., the temperature of the third forming wheel is 55° C., the composite transparent board includes four layers in total (as shown in FIG. 4), and the stacking sequence is C/B/A/C.

In Exemplary Example 4, the first resin is Tairilin P115, the second resin is Tairilin 3842, the third resin is Tairilin 380R, the intrinsic viscosity of the first resin is 1.1 dl/g, the intrinsic viscosity of the second resin is 0.84 dl/g, the intrinsic viscosity of the third resin is 0.8 dl/g, the thickness of the first layer accounts for 60%, the thickness of the second layer accounts for 30%, the thickness of the third layer accounts for 10%, the temperature of the first forming wheel is 20° C., the temperature of the second forming wheel is 22° C., the temperature of the third forming wheel is 55° C., the composite transparent board includes three layers in total (as shown in FIG. 5), and the stacking sequence is C/B/A.

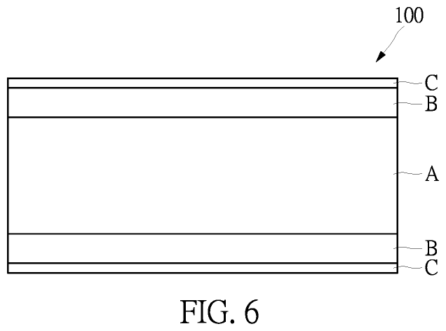

In Exemplary Example 5, the first resin is Tairilin 663G, the second resin is Tairilin 3842, the third resin is Tairilin 3842, the intrinsic viscosity of the first resin is 0.63 dl/g, the intrinsic viscosity of the second resin is 0.84 dl/g, the intrinsic viscosity of the third resin is 0.84 dl/g, the thickness of the first layer accounts for 60%, the thickness of the second layer accounts for 30%, the thickness of the third layer accounts for 10%, the temperature of the first forming wheel is 20° C., the temperature of the second forming wheel is 20° C., the temperature of the third forming wheel is 53° C., the composite transparent board includes five layers in total (as shown in FIG. 6), and the stacking sequence is C/B/A/B/C.

In Exemplary Example 6, the first resin is SKYGREEN® S2008, the second resin is Tairilin 3842, the third resin is Tairilin 384R, the intrinsic viscosity of the first resin is 0.75 dl/g, the intrinsic viscosity of the second resin is 0.84 dl/g, the intrinsic viscosity of the third resin is 0.84 dl/g, the thickness of the first layer accounts for 60%, the thickness of the second layer accounts for 30%, the thickness of the third layer accounts for 10%, the temperature of the first forming wheel is 20° C., the temperature of the second forming wheel is 20° C., the temperature of the third forming wheel is 53° C., the composite transparent board includes five layers in total (as shown in FIG. 6), and the stacking sequence is C/B/A/B/C.

In Comparative Example 1, the first resin is Tairilin 663G, no second resin and third resin are used, the intrinsic viscosity of the first resin is 0.63 dl/g, the thickness of the first layer accounts for 100%, the temperature of the first forming wheel is 20° C., the temperature of the second forming wheel is 20° C., and the temperature of the third forming wheel is 53° C.

In Comparative Example 2, the first resin is Tairilin 3760, no second resin and third resin are used, the intrinsic viscosity of the first resin is 0.76 dl/g, the thickness of the first layer accounts for 100%, the temperature of the first forming wheel is 18° C., the temperature of the second forming wheel is 18° C., and the temperature of the third forming wheel is 51° C.

Components and parameters of each component in Exemplary Examples 1 to 6 and Comparative Examples 1 and 2 are listed in Table 1 below, and relevant testing methods are described as follows.

A haze test is carried out according to ISO14782. A haze value=diffuse light transmittance/total light transmittance×100%.

Measuring of a total light transmittance is carried out according to ISO 14782. The total light transmittance=outgoing light/incident light×100%.

TABLE 1
[Components of Exemplary Examples and Comparative Examples
and Test Results of Their Physical and Chemical Properties]

| | | Exemplary | Exemplary | Exemplary | Exemplary |
|---|---|---|---|---|---|
| Item | | Example 1 | Example 2 | Example 3 | Example 4 |
| Parameter | component of | Tairilin | Tairilin | Tairilin | Tairilin |
| of each | first resin | 3824 | 3842 | 390A | P115 |
| component | component of | Tairilin | Tairilin | Tairilin | Tairilin |
| | second resin | 3760 | 3842 | 3842 | 3842 |
| | component of | Tairilin | Tairilin | Tairilin | Tairilin |
| | third resin | 3760 | 3760 | 3842 | 380R |
| | intrinsic viscosity | 0.82 | 0.84 | 0.9 | 1.1 |
| | of first resin (dl/g) | | | | |
| | intrinsic viscosity | 0.76 | 0.84 | 0.84 | 0.84 |
| | of second resin (dl/g) | | | | |
| | intrinsic viscosity | 0.76 | 0.76 | 0.84 | 0.8 |
| | of third resin (dl/g) | | | | |
| | thickness ratio of | 40 | 70 | 60 | 60 |
| | first layer (%) | | | | |
| | thickness ratio of | 40 | 15 | 30 | 30 |
| | second layer (%) | | | | |
| | thickness ratio of | 20 | 15 | 10 | 10 |
| | third layer (%) | | | | |
| | temperature of first | 18 | 20 | 18 | 20 |
| | forming wheel (° C.) | | | | |
| | temperature of | 18 | 20 | 18 | 22 |
| | second forming | | | | |
| | wheel (° C.) | | | | |
| | temperature of | 51 | 58 | 55 | 55 |
| | third forming | | | | |
| | wheel (° C.) | | | | |
| | quantity of layers | 5 | 4 | 4 | 3 |
| | of composite | | | | |
| | transparent board | | | | |
| | stacking sequence | C/B/A/B/C | C/B/A/B | C/B/A/C | C/B/A |
| | of composite | | | | |
| | transparent board | | | | |
| Test | thickness of | 6 | 0.5 | 6 | 4 |
| results | composite transparent | | | | |
| | board (mm) | | | | |
| | forming result | good | good | good | good |
| | haze of composite | 2.85 | 0.75 | 2.1 | 1.5 |
| | transparent board (%) | | | | |
| | total light | 87.5 | 91.5 | 88.6 | 88.5 |
| | transmittance of | | | | |
| | composite transparent | | | | |
| | board (%) | | | | |
| | bubbles on surface | no | no | no | no |
| | of composite | | | | |
| | transparent board | | | | |
| | surface whitening | no | no | no | no |
| | phenomenon of | | | | |
| | composite | | | | |
| | transparent board | | | | |

| | | Exemplary | Exemplary | Comparative | Comparative |
|---|---|---|---|---|---|
| Item | | Example 5 | Example 6 | Example 1 | Example 2 |
| Parameter | component of | Tairilin | SKYGREEN ® | Tairilin | Tairilin |
| of each | first resin | 663G | S2008 | 663G | 3760 |
| component | component of | Tairilin | Tairilin | no | no |
| | second resin | 3842 | 3842 | | |
| | component of | Tairilin | Tairilin | no | no |
| | third resin | 3842 | 384R | | |
| | intrinsic viscosity | 0.63 | 0.75 | 0.63 | 0.76 |
| | of first resin (dl/g) | | | | |
| | intrinsic viscosity | 0.84 | 0.84 | no | no |
| | of second resin (dl/g) | | | | |
| | intrinsic viscosity | 0.84 | 0.84 | no | no |
| | of third resin (dl/g) | | | | |
| | thickness ratio of | 60 | 60 | 100 | 100 |
| | first layer (%) | | | | |
| | thickness ratio of | 30 | 30 | no | no |
| | second layer (%) | | | | |
| | thickness ratio of | 10 | 10 | no | no |
| | third layer (%) | | | | |
| | temperature of first | 20 | 20 | 20 | 18 |
| | forming wheel (° C.) | | | | |
| | temperature of | 20 | 20 | 20 | 18 |
| | second forming | | | | |
| | wheel (° C.) | | | | |
| | temperature of | 53 | 53 | 53 | 51 |
| | third forming | | | | |
| | wheel (° C.) | | | | |
| | quantity of layers | 5 | 5 | 1 | 1 |
| | of composite | | | | |
| | transparent board | | | | |
| | stacking sequence | C/B/A/B/C | C/B/A/B/C | A | A |
| | of composite | | | | |
| | transparent board | | | | |
| Test | thickness of | 3 | 8 | 5 | 4 |
| results | composite transparent | | | | |
| | board (mm) | | | | |
| | forming result | good | good | poor | good |
| | haze of composite | 1.75 | 2.15 | no | 5.85 |
| | transparent board (%) | | | | |
| | total light | 89.3 | 87.1 | no | 82 |
| | transmittance of | | | | |
| | composite transparent | | | | |
| | board (%) | | | | |
| | bubbles on surface | no | no | yes | no |
| | of composite | | | | |
| | transparent board | | | | |
| | surface whitening | no | no | no | yes |
| | phenomenon of | | | | |
| | composite | | | | |
| | transparent board | | | | |

### [Discussion of Test Results]

As shown in Exemplary Examples 1 to 6, through adopting specific materials and parameters, the composite transparent board can have a good forming result, a haze within a range from 0.75% to 2.85%, and a total light transmittance within a range from 87.5% to 91.5%.

As shown in Exemplary Example 5 and Comparative Example 1, the composite transparent board of Comparative Example 1 only includes a single first layer, the component of the first resin is Tairilin 663G, and the intrinsic viscosity of the first resin is 0.63 dl/g. Since the intrinsic viscosity is relatively low, the forming result is poor. However, the component drips during forming and cannot be shaped into a board, or has obvious bubbles. In Exemplary Example 5, the first layer is covered by the second layer and the third layer made of resin having high intrinsic viscosity, such that the components can be normally processed to form the composite transparent board.

As shown in Exemplary Example 1 and Comparative Example 2, the composite transparent board of Comparative Example 2 only includes a single first layer, the component of the first resin is Tairilin 3760, and the composite transparent board has a crystallizing and whitening phenomenon when the composite transparent board is processed to 4 mm. Accordingly, the haze of the composite transparent board is too high, the total light transmittance of the composite transparent board is too low, and the composite transparent board of Comparative Example 2 does not meet the property requirement of the composite transparent board. The composite transparent board of Exemplary Example 1 is in a five-layered structure, the component of the first resin is Tairilin 3824, the component of the second resin is Tairilin 3760, and the component of the third resin is Tairilin 3760. The composite transparent board of Exemplary Example 1 does not have the crystallizing and whitening phenomenon when the composite transparent board is processed to 6 mm. The composite transparent board of Exemplary Example 1 has a haze of 2.85% and a total light transmittance of 88% and meets the property requirement of the composite transparent board.

### Beneficial Effects of the Embodiments

In conclusion, in the composite transparent board and method for producing the same provided by the present disclosure, by virtue of the first resin being selected from the group consisting of Tairilin 3824, Tairilin 3842, Tairilin 390A, Tairilin P115, Tairilin 663G, and SKYGREEN® $2008, the second resin being selected from the group consisting of Tairilin 3760 and Tairilin 3842, and the third resin being selected from the group consisting of Tairilin 3760, Tairilin 3842, Tairilin 380R, and Tairilin 384R, the crystallizing and whitening phenomenon of the conventional transparent board during a forming process thereof can be prevented.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for producing a composite transparent board, comprising:
a feeding step implemented by respectively feeding a first resin, a second resin, and a third resin into a first extruder, a second extruder, and a third extruder to correspondingly form a composite transparent film including a first layer, a second layer, and a third layer; wherein the first resin is selected from the group consisting of Tairilin 3824, Tairilin 3842, Tairilin 390A, Tairilin P115, Tairilin 663G, and SKYGREEN® S2008, the second resin is selected from the group consisting of Tairilin 3760 and Tairilin 3842, and the third resin is selected from the group consisting of Tairilin 3760, Tairilin 3842, Tairilin 380R, and Tairilin 384R; and
a forming step implemented by sequentially passing the composite transparent film through a first forming wheel, a second forming wheel, and a third forming wheel to form a composite transparent board; wherein an absolute value of a difference between a temperature of the first forming wheel and a temperature of the second forming wheel is less than or equal to 5° C., and a ratio between a temperature of the third forming wheel and the temperature of the first forming wheel or the temperature of the second forming wheel is within a range from 1.8 to 3.5,
wherein the composite transparent board has a haze within a range from 0.75% to 4% and a total light transmittance within a range from 86% to 91.5%.

2. The method according to claim 1, wherein the first resin has an intrinsic viscosity within a range from 0.63 dl/g to 1.1 dl/g, the second resin has an intrinsic viscosity within a range from 0.76 dl/g to 1.1 dl/g, and the third resin has an intrinsic viscosity within a range from 0.76 dl/g to 1.1 dl/g.

3. The method according to claim 1, wherein the temperature of the first forming wheel is within a range from 18° C. to 25° C., the temperature of the second forming wheel is within a range from 18° C. to 25° C., and the temperature of the third forming wheel is within a range from 35° C. to 58° C.

4. The method according to claim 1, wherein the first layer, the second layer, and the third layer of the composite transparent board are arranged, from top to bottom, in one of following sequences: the third layer, the second layer, the first layer, the second layer, and the third layer; the third layer, the second layer, the first layer, and the second layer; the third layer, the second layer, the first layer, and the third layer; and the third layer, the second layer, and first layer.

5. The method according to claim 1, wherein, based on a thickness of the composite transparent board being 100%, a thickness of the first layer accounts for 40% to 70%, a thickness of the second layer accounts for 15% to 40%, and a thickness of the third layer accounts for 10% to 20%.

6. The method according to claim 1, wherein the first resin has a melting temperature of less than 246° C. or has no melting temperature, the second resin has a melting temperature within a range from 246° C. to 255° C., and the third resin has a melting temperature within a range from 246° C. to 255° C.

7. The method according to claim 1, wherein a thickness of the composite transparent board is within a range from 0.5 mm to 8 mm.

8. A composite transparent board, comprising:
a first layer made of a first resin, wherein the first resin is selected from the group consisting of Tairilin 3824, Tairilin 3842, Tairilin 390A, Tairilin P115, Tairilin 663G, and SKYGREEN® S2008;
a second layer made of a second resin, wherein the second resin is selected from the group consisting of Tairilin 3760 and Tairilin 3842; and
a third layer made of a third resin, wherein the third resin is selected from the group consisting of Tairilin 3760, Tairilin 3842, Tairilin 380R, and Tairilin 384R,
wherein the composite transparent board has a haze within a range from 0.75% to 4% and a total light transmittance within a range from 86% to 91.5%.

9. The composite transparent board according to claim 8, wherein the first resin has an intrinsic viscosity within a range from 0.63 dl/g to 1.1 dl/g, the second resin has an intrinsic viscosity within a range from 0.76 dl/g to 1.1 dl/g, and the third resin has an intrinsic viscosity within a range from 0.76 dl/g to 1.1 dl/g.

10. The composite transparent board according to claim 8, wherein the first layer, the second layer, and the third layer of the composite transparent board are arranged, from top to bottom, in one of following sequences: the third layer, the second layer, the first layer/second layer, and the third layer; the third layer, the second layer, the first layer, and the second layer; the third layer, the second layer, and the first layer/third layer; and the third layer, the second layer, and the first layer.

11. The composite transparent board according to claim 8, wherein, based on a thickness of the composite transparent board being 100%, a thickness of the first layer accounts for 40% to 70%, a thickness of the second layer accounts for 15% to 40%, and a thickness of the third layer accounts for 10% to 20%.
